(19) United States
(12) Patent Application Publication
(10) Pub. No.: US 2007/0006287 A1
(43) Pub. Date: Jan. 4, 2007

(54) Authentication information input electronic device, authentication information input method and authentication information input program product

(75) Inventor: Hisashi Noda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/475,087

(22) Filed: Jun. 27, 2006

(30) Foreign Application Priority Data
Jul. 1, 2005 (JP) 2005-193474

(51) Int. Cl. H04L 9/32

(52) U.S. Cl. 726/4

(57) ABSTRACT

An authentication information input electronic device, an authentication information input method and an authentication information input program product, which are capable of readily carrying out an authentication information input operation and improving secrecy of the authentication information. Character information constituting the authentication information, selected from the character information sequentially displayed on the display, is determined. The determined character information is converted into special character information different from the character information to display it on the display. In addition, a display speed of the character information sequentially displayed on the display can be accelerated or decelerated to control the display speed of the character information continuously displayed on the display.

### BACKGROUND OF THE INVENTION

The present invention relates to an electronic device for inputting authentication information, an authentication information input method implemented in the electronic device and an authentication information input program product, and more particularly to an authentication information input electronic device, an authentication information method and an authentication information input program product, which are capable of readily carrying out an authentication information input operation and improving secrecy of the authentication information.

When authentication information is input, in order to improve secrecy of the authentication information, certain characters called mask characters such as an asterisk “*” or the like are displayed. In this method, by means of a keyboard, the authentication information can be input directly and no problem arises in particular.

However, in the case of a mobile terminal device such as a mobile phone, it is difficult to save sufficient space for an operation section. Consequently, the mobile terminal device is designed so that plural characters are assigned to one operation key. For example, the operation section is provided with only numeric keys, and characters except numerals (alphabets, for example) are input by repeatedly operating a numeric key to display a desired character.

In such a conventional mobile terminal device for which it is difficult to keep a sufficient operation area, in order to input the authentication information without being known by other persons, every time the authentication information is input, the input authentication information is converted into the mask characters to display it on a monitor. However, in this method, the input authentication information is not displayed on the monitor and an operator cannot confirm the input authentication information on the monitor.

On the contrary, when the mobile terminal device is designed so that the mask characters are not displayed on the monitor when the authentication information is inputted, as shown in FIG. 1, a character string (“adminadmin”) of the authentication information is displayed on the monitor to increase the risk of authentication information leaks.

A conventional secret number input device has been proposed, as disclosed in Japanese Patent Application Laid-Open No. 11-191094 (Patent Document 1). In this case, the secret number input device includes a secret number input controller for controlling a secret number of a user, a secret number storage buffer for storing the secret number, an UP switch for increasing a number displayed on a monitor, a DOWN switch for decreasing the number displayed on the monitor and a set switch for determining the number selected by using the UP and DOWN switches. Even when the switches pushed by the user are seen by others positioning in a line behind or around the user while the user inputs the secret number, the numbers used in the secret number cannot be known by others.

A conventional mobile information terminal device has been developed, as disclosed in Japanese Patent Application Laid-Open No. 2001-337734 (Patent Document 2). In this mobile information terminal device, an operator can authenticate an input password. In this case, character information of the password inputted using keys is displayed on a monitor, when the operator inputs or sets the password, and after the predetermined time passes, the character information is converted into mask symbols for indicating masking of the display of the input character information to display the mask symbols again on the monitor. In this mobile information terminal device, the password input with secrecy can be conducted and the operator can exactly confirm a proper character information input.

A conventional secret code input device has been also developed, as disclosed in Japanese Patent Application Laid-Open No. 8-190451 (Patent Document 3). In this secret code input device, a symbol table including at least one kind of symbol is displayed on a monitor and symbols are sequentially selected from the symbol table to construct a symbol string composed of at least one symbol to obtain a secret code of the symbol string. This secret code input device includes a timer for producing a trigger signal at a certain time interval, a symbol table controller for executing a highlight display of one symbol within the symbol table and consecutively changing the highlighted symbol every detection of the trigger signal, an on-off switch and means for producing the highlighted symbol as a secret code component symbol when the on-off switch is turned on, resulting in ensuring secrecy of the secret code.

A conventional information processing device has been further proposed, as disclosed in Japanese Patent Application Laid-Open No. 7-261902 (Patent Document 4). In this information processing device, while one character key is pushed down, characters assigned to this key are continuously changed and displayed. When the desired character is displayed, the key is released to input the displayed character. As a result, a character change operation can be readily carried out in a character input operation from a keyboard.

In the Patent Document 1, by the number determining operation using the set switch, the number selected by the user is overwritten by the mask characters for displaying to prevent the numbers used in the secret number from being known by others. In this case, when the user selects the numbers of the secret number, plural operations are required and no consideration is taken for simplifying the operation for selecting the numbers of the secret number.

In the Patent Document 2, the character information of the password input using the keys is displayed on the monitor and after the predetermined time passes, the character information displayed on the monitor is converted into the mask symbols to display the mask symbols again on the monitor, enabling the operator to input the password with the secrecy. In this instance, since the character information inputted using the keys is displayed on the monitor, no consideration is taken for simplifying the operation for selecting the character information of the password.

In the Patent Document 3, one highlighted symbol within the symbol table displayed on the monitor is sequentially changed by the trigger signal produced at the certain time interval by the timer, ensuring the secrecy of the secret code. In this case, since the symbol table is displayed on the monitor in advance and no consideration is taken for continuously displaying the character information in a small area. Further, although the Patent Document 3 discloses that the change speed of the highlighted symbol display can be operated by a manual operation of the timer, its operation method is not described specifically.

In the Patent Document 4, although the continuous change and display of the characters assigned to one key by keeping the pushing this key is disclosed, no consideration is taken for controlling the change speed of the characters displayed continuously. The Patent Document 4 concerns the information processing device for implementing the keyboard operation and no consideration is given to a mobile terminal device with difficulty in keeping a sufficient operation part.

### SUMMARY OF THE INVENTION

It is therefore an object of the present invention to provide an authentication information input electronic device, method and program in view of the aforementioned problems in the conventional art, which is capable of readily carrying out an authentication information input operation and improving secrecy of the authentication information.

In accordance with one aspect of the present invention, there is provided an authentication information input electronic device comprising: a display for sequentially displaying character information constituting authentication information; a determiner for determining the character information, selected from the character information sequentially displayed on the display; a converter for converting the character information determined by the determiner into special character information different from the character information to display the special character information again on the display; and a speed controller for controlling a display speed of the character information sequentially displayed on the display, the speed controller including an accelerator for accelerating the display speed of the character information and a decelerator for decelerating the display speed of the character information.

The authentication information input electronic device may further comprise a selector for selecting character information, the display sequentially displaying the character information.

The authentication information input electronic device may further comprise a storage section for storing character information, the selector including a plurality of selecting means, the storage section storing multiple pieces of character information assigned to each selecting means, the display reading the multiple pieces of character information assigned to one selecting means out of the storage section when the selecting means is selected, and sequentially displaying the multiple pieces of character information assigned to the selecting means.

In the authentication information input electronic device, the display may include means for sequentially displaying the multiple pieces of character information depending on the number of times the selector is operated.

The authentication information input electronic device may further comprise a change means for sequentially displaying the character information in reverse order on the display.

In the authentication information input electronic device, the change means sequentially displays the character information in reverse order on the display when the display speed of the character information is halted by the decelerator and the display speed of the character information is further decelerated by the decelerator.

In the authentication information input electronic device, the decelerator accelerates the display speed of the character information when the character information is sequentially displayed in reverse order by the change means, and the accelerator decelerates the display speed of the character information when the character information is sequentially displayed in reverse order by the change means.

The authentication information input electronic device can further comprise a release means for releasing the sequential display of the character information in reverse order.

In the authentication information input electronic device, the release means releases the sequential display of the character information in reverse order when the display speed of the character information is decelerated, the display of the character information is halted by the accelerator and the accelerator is further operated.

In the authentication information input electronic device, the determiner includes: a temporary determiner for temporarily determining the character information selected from the character information sequentially displayed on the display; and a duly determiner for duly determining the character information temporarily determined by the temporary determiner.

In accordance with another aspect of the present invention, there is provided an authentication information input method executed in an authentication information input electronic device having a display, comprising the steps of: sequentially displaying character information constituting authentication information on the display; determining the character information selected from the character information sequentially displayed on the display; converting the character information into special character information different from the character information to display the particular character information again on the display; and controlling a display speed of the character information, the display speed controlling step including accelerating the display speed of the character information and decelerating the display speed of the character information.

The authentication information input method may further comprise the step of selecting character information, the character information is sequentially displayed on the display.

In the authentication information input method, the authentication information input electronic device includes a plurality of selecting means and a storage section for storing multiple pieces of character information assigned to each selector, the display reading the multiple pieces of character information assigned to one selected selecting means out of the storage section when the selecting means is selected, and sequentially displaying the multiple pieces of character information assigned to the selecting means on the display.

In the authentication information input method, the multiple pieces of character information are sequentially displayed depending on the number of times the selecting means is operated.

The authentication information input method may further comprise the step of changing a display order to sequentially display the character information in reverse order on the display.

In the authentication information input method, the character information is sequentially displayed in reverse order on the display when the display of the character information is halted by deceleration of the display speed and the display speed is further decelerated.

In the authentication information input method, the decelerating step accelerates the display speed of the character information when the character information is in reverse order, and the accelerating step decelerates the display speed of the character information when the character information is in reverse order.

The authentication information input method may further comprise the step of releasing the sequential display of the character information in reverse order.

In the authentication information input method, the sequential display of the character information in reverse order is released when the display speed of the character information is decelerated and is halted in the accelerating step and the display speed of the character information is further decelerated in the accelerating step.

In the authentication information input method, the determining step includes the steps of: temporarily determining the character information selected from the character information sequentially displayed on the display; and duly determining the character information temporarily determined.

In accordance with a further aspect of the present invention, there is provided an authentication information input program product, when executed, causes an authentication information input electronic device having a display to perform the following: sequentially displaying character information constituting authentication information on the display; determining the character information selected from the character information sequentially displayed on the display; converting the character information into special character information different from the character information to display the special character information again on the display; and controlling a display speed of the character information sequentially displayed on the display, the display speed controlling process including accelerating and decelerating the display speed of the character information.

The authentication information input program product may further comprise the process of selecting character information sequentially displayed on the display, the display sequentially displaying the character information.

In the authentication information input program product, the authentication information input electronic device includes a plurality of selecting means and a storage section for storing multiple pieces of character information assigned to each selector, the display reading the multiple pieces of character information assigned to one selected selecting means out of the storage section when the selecting means is selected, and sequentially displaying the multiple pieces of character information assigned to the selecting means on the display.

In the authentication information input program product, the multiple pieces of character information is sequentially displayed depending on the number of time the selecting means is operated.

The authentication information input program product may further comprise the process of changing a display order to sequentially display the character information in reverse order on the display.

In the authentication information input program product, the character information is sequentially displayed in reverse order on the display when the display speed of the character information is halted by the decelerating process and the display speed of the character information is further decelerated in the decelerating process.

In the authentication information input program product, the decelerating process accelerates the display speed of the character information when the character information is sequentially displayed in reverse order, and the accelerating process decelerates the display speed of the character information when the character information is sequentially displayed in reverse order.

The authentication information input program product may further comprise the process of releasing the sequential display of the character information in reverse order.

In the authentication information input program product, the sequential display of the character information in reverse order is released when the display speed of the character information is decelerated in the accelerating process, is halted is further decelerated in the accelerating process.

In the authentication information input program product, the determining process includes the processes of: temporarily determining the character information selected from the character information sequentially displayed on the display; and duly determining the character information temporarily determined.

According to the present invention, the character information constituting the authentication information is sequentially displayed on the display and the character information constituting the authentication information, selected from the character information sequentially displayed on the display, is determined. The determined character information is converted into the special character information different from the character information to display the particular character information on the display. In addition, the display speed of the character information can be changed, that is, accelerated or decelerated on the display. Hence, the input operation of the authentication information can be readily carried out and the secrecy of the authentication information can be improved.

### BRIEF DESCRIPTION OF THE DRAWINGS

The objects, features and advantages of the present invention will become more apparent from the consideration of the following detailed description, taken in conjunction with the accompanying drawings, in which:

FIG. 1 is a plan view of a conventional mobile communication terminal device for explaining an input operation of authentication information;

FIG. 2 is a plan view of a mobile communication terminal device having a function of an authentication information input device according to the present embodiment;

FIG. 3 is a block diagram of a mobile communication terminal device according to a first embodiment of the present invention;

FIG. 4 is a diagram showing alphabets assigned to numeric keys of the mobile communication terminal device shown in FIG. 2;

FIG. 5 is a schematic diagram showing character information on a display of the mobile communication terminal device shown in FIG. 2;

FIG. 6 is a flow chart showing an authentication procedure executed in the mobile communication terminal device shown in FIG. 2 according to the first embodiment;

FIG. 7 is a flow chart showing an authentication procedure executed in the mobile communication terminal device shown in FIG. 2 according to a second embodiment;

FIG. 8 is a schematic diagram showing a selection operation of the character information according to the second embodiment;

FIG. 9 is a block diagram of a mobile communication terminal device according to a third embodiment; and

FIG. 10 is flow chart showing an authentication procedure executed in the mobile communication terminal device shown in FIG. 2 according to the third embodiment.

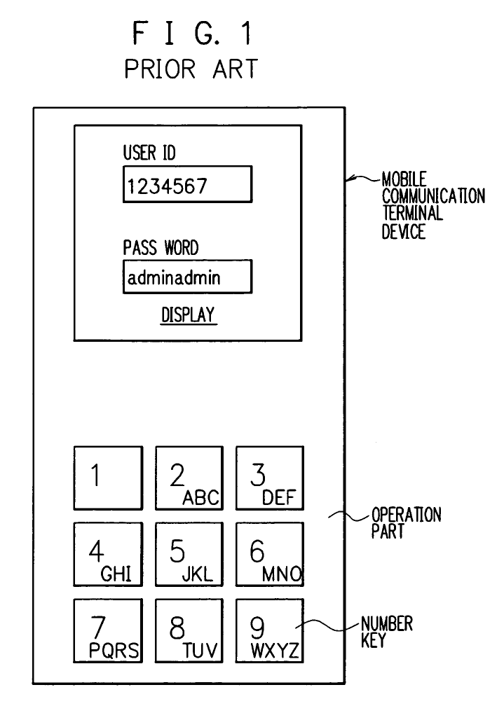

### DESCRIPTION OF THE PREFERRED EMBODIMENTS

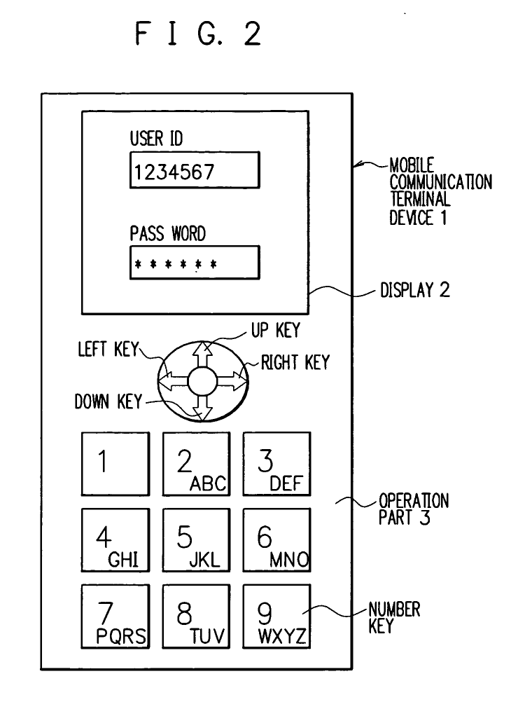

Referring now to FIG. 2, the external construction of a mobile communication terminal device according to this embodiment will be described.

In FIG. 2, the mobile communication terminal device 1 includes a display 2 and an operation section 3. Character information, which constitutes authentication information, is sequentially displayed on the display 2 by using the operation section 3 and an operator selects desired character information from the character information successively displayed on the display 2 by using the operation section 3 and determines the desired character information. The determined character information is converted into mask characters, which constitutes special character information and are displayed on the display 2.

A first embodiment of the present invention will be described in detail with reference to FIG. 2 to FIG. 6.

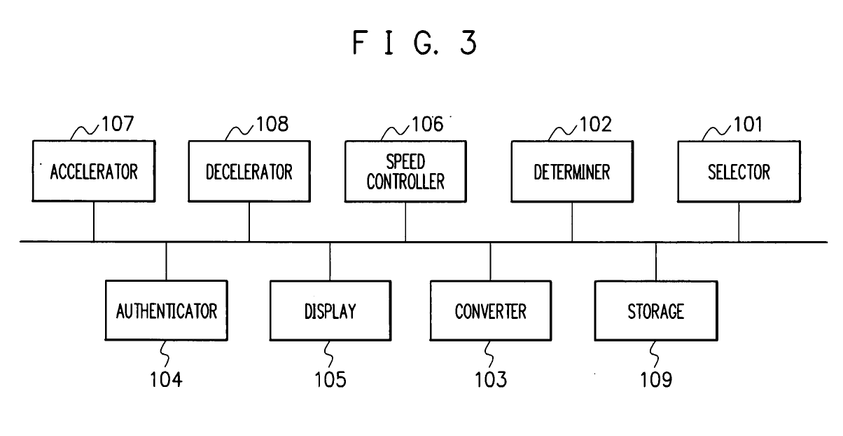

Features of an electronic device will be described with reference to FIG. 3.

In this embodiment, as shown in FIG. 3, the electronic device for inputting the authentication information includes a display 105 for sequentially displaying the character information, a selector 101 for selecting the desired character information from the character information displayed on the display 105, a determiner 102 for determining the desired character information selected by the selector 101, a converter 103 for converting the character information determined by the determiner 102 into the special character information such as the mask characters different from the character information for displaying the special character information on the display 105, an authenticator 104 for authenticating validity of the authentication information such as a password of the determined character information, a speed controller 106 for controlling a display speed of the character information consecutively displayed on the display 105, and a storage section 109 for storing the character information allocated to the selector 101. The speed controller 106 includes an accelerator 107 for accelerating the display speed of the character information and a decelerator 108 for decelerating the display speed of the character information.

In this embodiment, as described above, the character information is sequentially displayed on the display 105 and hence the input operation of the authentication information can be readily conducted. The character information selected from the character information continuously displayed on the display 105 is determined by the determiner 102 and the determined character information is converted into the special character information such as the mask characters to display the special character information again on the display 105, resulting in improving secrecy of the authentication information. In addition, in this embodiment, the display speed of the character information can be accelerated or decelerated and the input operation of the authentication information can be further readily carried out. In this embodiment, the electronic device includes a mobile communication terminal device such as a mobile phone, a PDA (personal digital assistance) and a PHS (personal handy phone system), a navigation system such as a car navigation system, a remote control device and the like. The electronic device will be described in detail with reference to a mobile communication terminal device as one example.

In FIG. 3, the selector 101 for selecting the character information displayed on the display 105 is composed of a plurality of numeric keys mounted on the operation section 3 of the mobile communication terminal device, as shown in FIG. 2. In the selector 101, when one numeric key is operated, the character information assigned to this numeric key is read out of the storage 109 and is consecutively displayed on the display 105 at a fixed display speed.

The determiner 102 determines the desired character information selected from the character information continuously displayed on the display 105. That is, in this embodiment, the selector 101 only selects the character information sequentially displayed on the display 105 and the determiner 102 determines the desired character information selected from the character information consecutively displayed on the display 105.

The converter 103 converts the character information determined by the determiner 102 into mask characters and the mask characters are displayed again on the display 105.

The display 105 displays the character information selected by the selector 101 and the mask characters converted from the determined character information by the converter 103.

The authenticator 104 authenticates the validity of the authentication information composed of the character information determined by the determiner 102. For example, it is checked whether the authentication information of the character information determined by the determiner 102 coincides with the authentication information previously registered in the mobile communication terminal device and, when both the authentication information coincides with each other, its validity is authenticated.

The speed controller 106 controls the display speed of the character information continuously displayed on the display 105.

In the speed controller 106, the accelerator 107 accelerates the display speed of the character information displayed on the display 105. That is, the accelerator 107 sends acceleration command information to the speed controller 106 and the speed controller 106 accelerates the display speed of the character information displayed on the display 105 in response to the received acceleration command information. Similarly, the decelerator 108 sends deceleration command information to the speed controller 106 and the speed controller 106 decelerates the display speed of the character information displayed on the display 105 in response to the received deceleration command information.

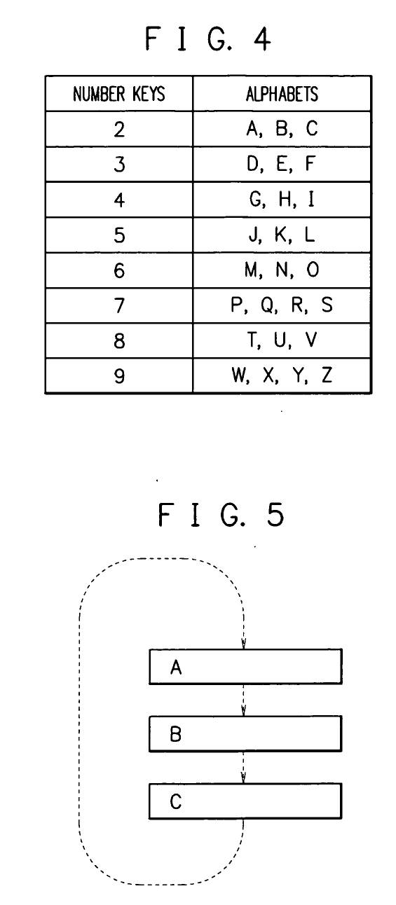

The storage section 109 stores the character information assigned to the numeric keys of the selector 101 and controls the character information. In this embodiment, as shown in FIG. 4, a plurality of alphabets are assigned to each of the numeric keys in the storage section 109. For instance, letters “A, B and C” are assigned to the numeric key “2” and other letters “D, E and F” are assigned to the numeric key “3”.

In the mobile communication terminal device, as shown in FIG. 2, when one of the keys of the selector 101 is pushed down, the letters assigned to the pushed key are read out of the storage section 109 and are successively displayed on the display 105 at a fixed display speed.

For example, in FIG. 2, when the numeric key “2” is pushed, the letters “A, B and C” assigned to the numeric key “2” are read out of the storage section 109 and are sequentially displayed on the display 105 in order of “A”→“B”→“C”→“A” at the fixed display speed, as shown in FIG. 5. On this occasion, after “C”, “A” is displayed again, that is, the letters are circularly displayed on the display 105.

When the numeric key “3” is pushed, similarly, the letters “D, E and F” assigned to the numeric key “3” are read out of the storage section 109 and are circularly displayed on the display 105 in order of “D”→“E”→“F”→“D” at the fixed display speed.

In this embodiment, the letters consecutively displayed on the display 105 are determined as the letter constituting the authentication information when the determiner 102 is operated. For example, if the determiner 102 is pushed whilst the letter “D” is displayed on the display 105, “D” is determined as the letter constituting the authentication information. Then the converter 103 converts the letter “D” into a mask character “*” and the converted mask character “*” is displayed again on the display 105.

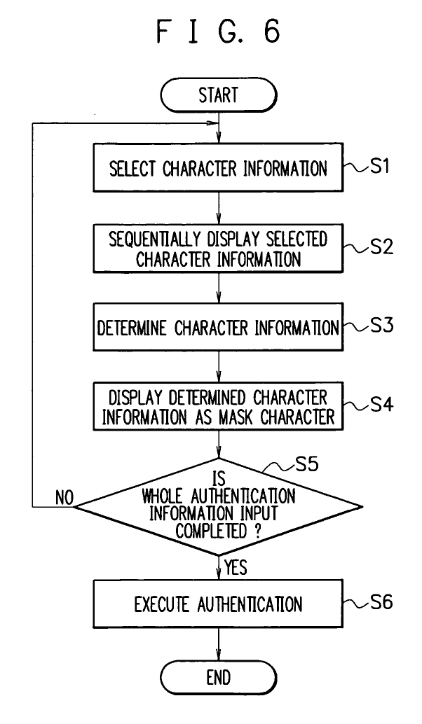

An authentication process in the mobile communication terminal device will be described in detail in connection with FIG. 2 and FIG. 6.

In this embodiment, it is assumed that authentication information “USERUSER” as a password is previously registered in the mobile communication terminal device. This authentication information, for instance, can be stored in the storage section 109.

First, an operator selects one of the numeric keys of the selector 101 in order to select one character of the character information at step S1. More specifically, the operator pushes the numeric key “8” in order to select the letter “U”.

When the numeric key “8” is pushed, the character information such as letters “T, U and V” assigned to the numeric key “8” is read out of the storage section 109 and the letters “T, U and V” are cyclically displayed on the display 105 in order of “T”→“U”→“V”→“T” at the predetermined display speed at step S2.

When the desired letter, that is, “U” is displayed on the display 105, the determiner 102 is pushed in order to determine the desired letter “U” at step S3.

In the case of this mobile communication terminal device, as shown in FIG. 2, by pushing a “RIGHT” key, a character determining operation of the determiner 102 is executed. The determined character information such as the letter “U” is converted into the mask character “*” by the converter 103 and the mask character “*” is displayed again on the display 105 at step S4.

When the selection of the whole character information constituting the authentication information is completed, the operator pushes the authenticator 104 and the mobile communication terminal device decides that the selection of the whole character information is completed at step S5/YES, carrying out an authentication operation at step S6.

At present, only one letter “U” is selected and since the selection of the whole character information of the authentication information is not yet completed (step S5/NO), the operation is returned to step S1. The operator pushes the numeric key “7” in order to select the desired letter “S” at step S1.

When the numeric key “7” is pushed, the character information such as letters “P, Q, R and S” assigned to the numeric key “7” is read out of the storage section 109 and the letters “P, Q, R and S” are cyclically displayed on the display 105 in order of “P”→“Q”→“R”→“S”→“P” at the predetermined display speed at step S2.

When the desired letter, that is, “S” is displayed on the display 105, the determiner 102 is pushed in order to determine the desired letter “S” at step S3. The letter “S” is converted into the mask character “*” by the converter 103 and the mask character “*” is displayed again on the display 105 at step S4.

In this way, the two characters of the character information are determined and the two determined characters are converted into the mask characters “*” to display on the display 105. In the same manner, the remaining characters of the character information are determined. When the selection of the whole character information is completed to display the whole characters as the mask characters on the display 105, the operator pushes the authenticator 104. Hence, the mobile communication terminal device decides that the selection of the whole character information is completed at step S5/YES and the authentication operation is conducted at step S6. The authenticator 104 verifies the authentication information displayed on the display 105 against the authentication information previously stored in the storage section 109 to authenticate the validity of the authentication information displayed on the display 105. When the authenticator 104 determines that the authentication information displayed on the display 105 coincides with the authentication information stored in the storage section 109, the authenticator 104 determines that the authentication information displayed on the display 105 is valid to finish the authentication processing operation.

In this embodiment, when the display speed of the character information sequentially displayed on the display 105 is controlled, by using the accelerator 107 and the decelerator 108, the speed controller 106 controls the display speed of the character information. In the mobile communication terminal device shown in FIG. 2, an “UP” key and a “DOWN” key are used as the accelerator 107 and the decelerator 108, respectively.

For instance, when the display speed of the character information continuously displayed on the display 105 is too quick for the operator to recognize, the operator keeps pushing the decelerator 108. Then, the deceleration command information is sent from the decelerator 108 to the speed controller 106 and the speed controller 106 decelerates the display speed of the character information on the basis of the received deceleration command information. When the display speed of the character information becomes proper, the decelerator 108 is released and the character information is continuously displayed on the display 105 at the proper display speed. The display speed is fixed at the moment the decelerator 108 is released.

On the other hand, when the display speed is so slow that others can easily recognize characters, the operator keeps pushing the accelerator 107. Then the acceleration command information is sent from the accelerator 107 to the speed controller 106 and the speed controller 106 accelerates the display speed on the basis of the received acceleration command information. When the display speed of the character information consecutively displayed on the display 105 becomes proper, the accelerator 107 is released and the character information is continuously displayed on the display 105 at the proper display speed. The display speed is fixed at the moment the accelerator 107 is released.

As described above, in this embodiment, the character information selected by the selector 101 is sequentially displayed on the display 105 at the fixed display speed and hence the number of the operations for selecting the character information with the selector 101 can be reduced. Furthermore, the operator determines the desired character information selected from the character information sequentially displayed on the display 105 by using the determiner 102 and the determined character information is converted into the mask characters by the converter 103 to display the converted mask characters again on the display 105. As a result, the secrecy of the authentication information can be improved.

Moreover, in this embodiment, the display speed of the character information consecutively displayed on the display 105 can be controlled by the speed controller 106 and hence the character information can be sequentially displayed on the display 105 at the display speed desired by the operator. The speed controller controls the display speed of the character information to the display speed desired by the operator by using the accelerator 107 for accelerating the display speed and the decelerator 108 for decelerating the display speed.

A second embodiment of the present invention will be described in detail with reference to FIG. 2 and FIG. 7 to FIG. 8.

Although in the aforementioned first embodiment, the character information selected by the selector 101 is sequentially displayed on the display 105 at the predetermined display speed, in a mobile communication terminal device according to the second embodiment, the character information selected by the selector 101 is successively displayed on the display 105 depending on the number of times the selector 101 is operated. Hence, the character information desired by the operator can be selected based on the operated times of the selector 101.

When an operator wishes to input character information, a mode is changed to a character input mode and the desired character information is selected by repeatedly pushing the numeric keys shown in FIG. 2.

For example, a case where half-sized characters and numbers are input is considered. As shown in FIG. 2, the letters “A, B and C” are assigned to the numeric key “2”. When the letter “A” is selected, the numeric key “2” is pushed one time. When the letter “B” is selected, the numeric key “2” is pushed two times. When the letter “C” is selected, the numeric key “2” is pushed three times. In this manner, the characters desired by the operator can be displayed on the display 105. On this occasion, when the numeric key “2” is pushed further, the above-described steps are repeated and hence the letters are successively displayed in order of “A”→“B”→“C”→“A” on the display 105.

As described above, in this embodiment, the character information assigned to the numeric keys of the selector 101 is successively displayed on the display 105 depending on the operated times of the numeric keys.

The determiner 102 determines the character information selected by the selector 101. The selector 101 only selects the character information to be displayed on the display 105 and the determiner 102 determines the desired character information selected by the selector 101.

The converter 103 converts the character information determined by the determiner 102 into the mask characters and the obtained mask characters are displayed again on the display 105.

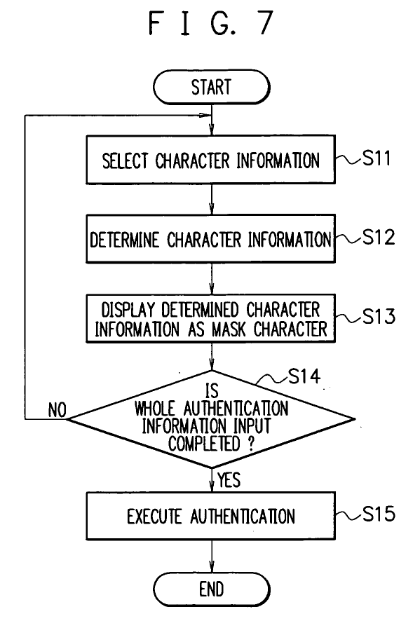

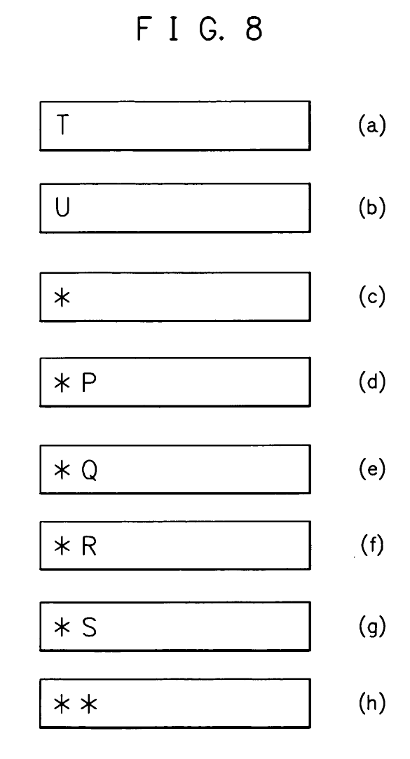

An authentication processing operation in the mobile communication terminal device will be described in detail. FIG. 7 illustrates an authentication procedure executed in the mobile communication terminal device according to the second embodiment of the present invention. FIG. 8 schematically shows a selection operation of the character information in the mobile communication terminal device.

In this embodiment, it is assumed that authentication information “USERUSER” as a password is previously registered in the mobile communication terminal device and this authentication information is stored in the storage section 109.

First, the operator selects one of the numeric keys of the selector 101 in order to select one character of the character information at step S11.

More specifically, the operator pushes the numeric key “8” in order to select the letter “U”. When the numeric key “8” is pushed one time, the letter “T” is displayed on the display 105, as shown in FIG. 8(a). However, the character information such as the letter “T”, which was selected by the numeric key of the selector 101 and displayed on the display, is not yet determined as the character information.

When the numeric key “8” is pushed one more time, the letter “U” is displayed on the display 105, as shown in FIG. 8(b). Since the letter “U” is the desired character information, this letter is determined by using the determiner 102 at step S12.

The character information such as the letter “U” determined by the determiner 102 is converted into the mask character “*” by the converter 103 and, as shown in FIG. 8(c), the converted mask character “*” is displayed again on the display 105 at step S13. In this way, the first letter of the character information is determined and is displayed on the display 105 in the form of the mask character.

When the selection of the whole character information is completed, the operator pushes the authenticator 104 and the mobile communication terminal device decides that the selection of the whole character information is completed at step S14/YES, carrying out an authentication operation at step S15.

At present, only one letter “U” is selected and since the selection of the whole character information of the authentication information is not yet completed (step S14/NO), the operation is returned to step S1. The operator pushes the numeric key “7” in order to select the desired letter “S” in step S11. In the same manner as described above, when the numeric key “7” is pushed four times, the letters “P, Q, R and S” assigned to the numeric key “7” are sequentially displayed on the display 105 in order of “P”→“Q”→“R”→“S”, as shown in FIG. 8(d) to FIG. 8(g). The letter “S” is eventually displayed on the display 105. Since the letter “S” is the desired character information, this letter is determined by using the determiner 102 at step S12.

The character information such as the letter “S” determined by the determiner 102 is converted into the mask character “*” by the converter 103 and the converted mask character “*” is displayed again on the display 105 at step S13. In this manner, the second letter of the character information is further determined and is displayed on the display 105 in the form of the mask character, as shown in FIG. 8(h).

As described above, the two characters of the character information constituting the authentication information are determined and their mask characters “*” are displayed again on the display 105. In the same manner as described above, the remaining characters of the character information are determined. When the selection of the whole character information is completed to display the whole characters as the mask characters on the display 105, the operator pushes the authenticator 104. Hence, the mobile communication terminal device decides that the selection of the whole character information is completed at step S14/YES and the authentication operation is conducted at step S15. The authenticator 104 verifies the authentication information displayed on the display 105 against the authentication information previously stored in the storage section 109 to authenticate the validity of the authentication information displayed on the display 105. When the authenticator 104 determines that the authentication information displayed on the display 105 coincides with the authentication information stored in the storage section 109, the authenticator 104 determines that the authentication information displayed on the display 105 is valid to finish the authentication processing operation.

In this embodiment, as described above, the character information is selected and determined one by one and the determined character information is converted into the mask characters one by one to display the mask characters on the display 105. Hence, the input operation of the authentication information can be readily carried out and the secrecy of the authentication information can be improved. According to the present invention, the mobile communication terminal device can be constructed so that the operator may select either the authentication procedure of the first embodiment shown in FIG. 6 or the authentication procedure of the second embodiment shown in FIG. 7.

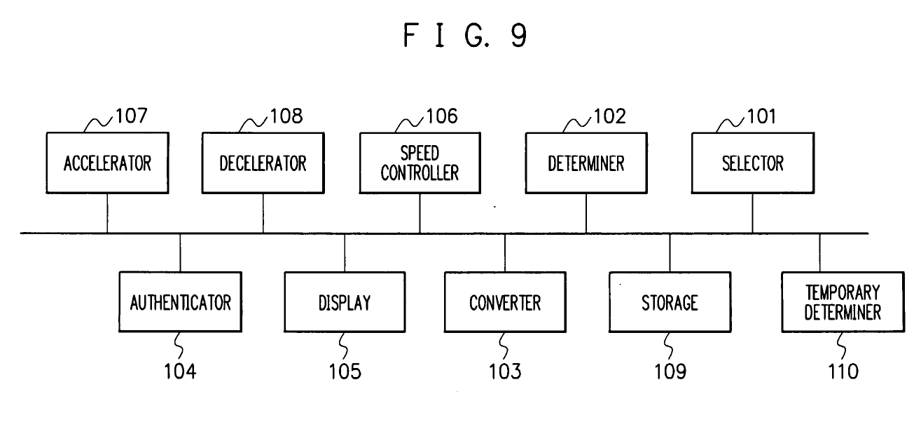

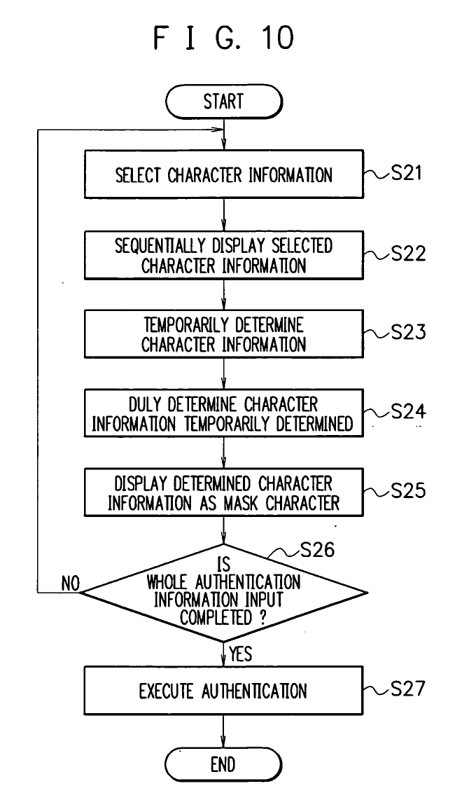

A third embodiment of the present invention will be described in detail with reference to FIG. 9 and FIG. 10.

Although in the aforementioned first embodiment, the character information selected by the selector 101 is sequentially displayed on the display 105 at the predetermined display speed and the desired character information selected from the character information continuously displayed on the display 105 is determined by the determiner 102 and is converted into the mask characters by the converter 103 to display the mask characters again on the display 105, in the third embodiment, a mobile communication terminal device is further provided with a temporary determiner 110 for temporarily determining the desired character information selected from the character information sequentially displayed on the display 105 before determining the desired information by the determiner 102.

In FIG. 9, there is shown a mobile communication terminal device having a function of an authentication information input device according to a third embodiment of the present invention. In this embodiment, the mobile communication device has the same construction as the electronic device of the first embodiment shown in FIG. 3 except that a temporary determiner 110 is added. In this instance, the desired character information selected from the character information sequentially displayed on the display 105 at the fixed display speed is temporarily determined by the temporary determiner 110. When the character information temporarily determined by the temporary determiner 110 is exactly the character information desired by the operator, the character information determined temporarily is eventually determined by the determiner 102. The determined character information is converted into the mask character by the converter 103 to display the mask character again on the display 105. Therefore, in this embodiment, since the character information temporarily determined by the temporary determiner 110 can be checked before the desired character information is determined by the determiner 102, an erroneous operation of the character information determination by the determiner 102 can be prevented in advance and an incorrect conversion from the character information into the mask character by the converter 103 can be reduced.

An authentication processing operation in the mobile communication terminal device will be described in detail in connection with FIG. 10, which shows an authentication procedure executed in the mobile communication terminal device according to the third embodiment of the present invention.

In this embodiment, it is assumed that authentication information “USERUSER” as a password is previously stored in the storage section 109.

First, an operator selects one of the numeric keys of the selector 101 in order to select one character of the character information at step S21. More specifically, the operator pushes the numeric key “8” in order to select the letter “U”.

When the numeric key “8” is pushed, the character information such as letters “T, U and V” assigned to the numeric key “8” is read out of the storage section 109 and the letters “T, U and V” are cyclically displayed on the display 105 in order of “T”→“U”→“V”→“T” at the predetermined display speed at step S22.

When the character information desired by the operator, that is, the letter “U” is displayed on the display 105, the temporary determiner 110 is pushed in order to temporarily determine the desired letter “U” at step S23. At this time, the character information consecutively displayed on the display 105 is stopped and the desired character information is temporarily determined to display the character information on the display 105. Hence, in this embodiment, the operator can check on the display 105 whether the character information determined temporarily, stopped and displayed on the display 105 is exactly the character information desired by the operator.

When the operator decides that the character information determined temporarily is exactly the character information desired by the operator, the character information is duly determined by pushing the determiner 102 at step S24. The determined character information such as the letter “U” is converted into the mask character “*” by the converter 103 and the mask character “*” is displayed again on the display 105 at step S25.

In the same manner as the first embodiment, the remaining characters of the character information are determined. When the selection of the whole character information is completed to display the whole characters as the mask characters on the display 105, the operator pushes the authenticator 104. Hence, the mobile communication terminal device decides that the selection of the whole character information is completed at step S26/YES and the authentication operation is conducted at step S27. The authenticator 104 verifies the authentication information displayed on the display 105 against the authentication information previously stored in the storage section 109 to authenticate the validity of the authentication information displayed on the display 105. When the authenticator 104 determines that the authentication information displayed on the display 105 coincides with the authentication information stored in the storage section 109, the authenticator 104 determines that the authentication information displayed on the display 105 is valid to finish the authentication procedure.

As described above, in this embodiment, the desired character information selected from the character information sequentially displayed on the display 105 is temporarily determined by the temporary determiner 110. When the character information temporarily determined by the temporary determiner 110 is exactly the character information desired by the operator, the character information is determined by the determiner 102, enabling the operator to convert the determined character information into the mask character by the converter 103. Hence, since the character information temporarily determined by the temporary determiner 110 can be checked before determining the desired character information by the determiner 102, an erroneous operation of the character information determination by the determiner 102 can be prevented in advance and an incorrect conversion from the character information into the mask character by the converter 103 can be reduced.

A fourth embodiment of the present invention will be described in detail.

Although in the first embodiment, the display speed of the character information sequentially displayed on the display 105 is changed stepwise depending on a time period while the accelerator 107 or the decelerator 108 is pushed. In the fourth embodiment, the display speed of the character information is changed stepwise depending of the number of times the accelerator 107 or the decelerator 108 is pushed. In this way, the display speed of the character information continuously displayed on the display 105 is changed in a discrete manner by the accelerator 107 or the decelerator 108 and hence the display speed desired by the operator can be set depending on times the accelerator 107 or the decelerator 108 is pushed.

Moreover, in this embodiment, concerning the accelerator 107 and the decelerator 108, a moving direction of the character information can be changed. For instance, when the display speed is decelerated while the decelerator 108 is pushed even after the display speed becomes 0, the character information sequentially displayed on the display 105 is displayed in reverse. That is, as shown in FIG. 5, when the character information is displayed in order of “A”→“B”→“C”→“A”, it is displayed in reverse order of “C”→“B”→“A”→“C”. In addition, if the decelerator 108 is kept pressed after the character information is displayed in reverse order, the display speed of the character information in reverse order is accelerated stepwise.

When the character information consecutively displayed in reverse order is got back to the normal order, the operator keeps pushing the accelerator 107 to decelerate the display speed of the character information sequentially displayed in reverse order and, even when the display speed in reverse order becomes 0, the operator further keeps pushing the accelerator 107 to change the display order of the character information from the reverse order to the normal order. Furthermore, a release means for releasing the display of the character information in reverse order to its normal display order may be included. Hence, by operating this release means, the character information consecutively displayed in reverse order can be changed to being displayed in the normal order. Moreover, a display order change means for changing the display order between the normal display order and the reverse display order may be included. By operating this display order change means, the display order of the character information can be simply changed between the normal display order and the reverse display order.

Furthermore, an authentication information temporary display means for displaying the authentication information for a certain time period may be constructed, enabling to display the authentication information on the display while the authentication information temporary display means is pushed. As a result, the authentication information can be temporarily displayed on the display for confirming the authentication information and the input operation of the authentication information can be continued.

While the present invention has been described with reference to the particular illustrative embodiments, it is not to be restricted by those embodiments but only by the appended claims. It is to be appreciated that those skilled in the art can change and modify the embodiments without departing from the scope and spirit of the present invention.

For instance, although the character information determined by the determiner 102 is converted into the mask character such as the asterisk “*” by the converter 103 to display the mask character again on the display in the above-described embodiments, according to the present invention the converted character obtained by the converter 103 is not restricted to the mask character such as the asterisk and any special character information capable of ensuring the secrecy of the character information determined by the determiner 102 can be employed. Further, any special character information obtained by the converter can be determined.

Moreover, although the authentication procedure in the aforementioned mobile communication terminal device is implemented by using the hardware construction, the authentication procedure may be performed using software such as computer programs. Further, the above-described programs can be stored in storage such as an optical recording medium, a magnetic recording medium, an optical magnetic recording medium, a semiconductor recording medium and the like and the programs read out of the storage are read into an information processing device to execute the above-described procedure in the information processing device. Moreover, the programs can be read into the information processing device from an external device connected to the information processing device via a certain network to implement the aforementioned processing operation in the information processing device.

Furthermore, an authentication information input electronic device, an authentication information input method and an authentication information input program according to the present invention can be applied to electronic devices that have difficulty in ensuring a sufficient area for an operation section such as a mobile communication terminal device, a car navigation system, a remote control device and the like.

What is claimed is:

1. An authentication information input electronic device comprising:
a display for sequentially displaying character information constituting authentication information;
a determiner for determining the character information, selected from the character information sequentially displayed on the display;
a converter for converting the character information determined by the determiner into special character information different from the character information to display the special character information again on the display; and
a speed controller for controlling a display speed of the character information sequentially displayed on the display,
wherein the speed controller includes an accelerator for accelerating the display speed of the character information and a decelerator for decelerating the display speed of the character information.

2. The authentication information input electronic device according to claim 1, further comprising a selector for selecting character information, wherein the display sequentially displays the character information.

3. The authentication information input electronic device according to claim 2, further comprising a storage section for storing and controlling the character information, wherein
the selector includes a plurality of selecting means,
the storage section stores multiple pieces of character information assigned to each selecting means,
the display reads the multiple pieces of character information assigned to one selecting means out of the storage section when the selecting means is selected, and sequentially displays the multiple pieces of character information assigned to the selected selecting means.

4. The authentication information input electronic device according to claim 2, wherein the display includes means for sequentially displaying the multiple pieces of character information depending on the number of times the selector is operated.

5. The authentication information input electronic device according to claim 1, further comprising a change means for sequentially displaying the character information in reverse order on the display.

6. The authentication information input electronic device according to claim 5, wherein the change means sequentially displays the character information in reverse order on the display when the display of the character information comes to a halt by the decelerator and the display speed of the character information is further decelerated by the decelerator.

7. The authentication information input electronic device according to claim 5, wherein the decelerator accelerates the display speed of the character information when the character information is sequentially displayed in reverse order by the change means, and the accelerator decelerates the display speed of the character information when the character information is sequentially displayed in reverse order by the change means.

8. The authentication information input electronic device according to claim 5, further comprising a release means for releasing the sequential display of the character information in reverse order.

9. The authentication information input electronic device according to claim 8, wherein the release means releases the sequential display of the character information in reverse order when the display speed of the character information is decelerated and the display of the character information is halted by the accelerator and the accelerator is further operated.

10. The authentication information input electronic device according to claim 1, wherein the determiner includes:
a temporary determiner for temporarily determining the character information selected from the character information sequentially displayed on the display; and
a duly determiner for duly determining the character information temporarily determined by the temporary determiner.

11. An authentication information input method executed in an authentication information input electronic device having a display, comprising the steps of:
sequentially displaying character information constituting authentication information on the display;
determining the character information selected from the character information sequentially displayed on the display;
converting the character information into special character information different from the character information to display the special character information again on the display; and
controlling a display speed of the character information,
wherein the display speed controlling step including accelerating the display speed of the character information and decelerating the display speed of the character information.

12. The authentication information input method according to claim 11, further comprising the step of selecting character information wherein character information is displayed on the display.

13. The authentication information input method according to claim 12, wherein the authentication information input electronic device includes a plurality of selecting means and a storage section for storing multiple pieces of character information assigned to each selector, and
the multiple pieces of character information assigned to a selecting means are read out of the storage section when the selecting means is selected, and are sequentially displayed on the display.

14. The authentication information input method according to claim 12, wherein the multiple pieces of character information are sequentially displayed depending on the number of times the selecting means is operated.

15. The authentication information input method according to claim 11, further comprising the step of changing a display order to sequentially display the character information in reverse order on the display.

16. The authentication information input method according to claim 15, wherein the character information is sequentially displayed in reverse order on the display when the display of the character information is halted by deceleration of the display speed and the display speed is further decelerated.

17. The authentication information input method according to claim 15, wherein the decelerating step accelerates the display speed of the character information when the character information is in reverse order, and the accelerating step decelerates the display speed of the character information when the character information is in reverse order.

18. The authentication information input method according to claim 15, further comprising the step of releasing the sequential display of the character information in reverse order.

19. The authentication information input method according to claim 18, wherein the sequential display of the character information in reverse order is released when the display speed of the character information is decelerated and is halted in the accelerating step, and the display speed of the character information is further decelerated in the accelerating step.

20. The authentication information input method according to claim 11, wherein the determining step includes the steps of:
temporarily determining character information selected from the character information sequentially displayed on the display; and
duly determining the character information temporarily determined.

21. The authentication information input program product that, when executed, causes an authentication information input electronic device having a display to perform the following:
sequentially displaying character information constituting authentication information on the display;
determining the character information selected from the character information sequentially displayed on the display;
converting the character information into special character information different from the character information to display the special character information again on the display; and
controlling a display speed of the character information,
wherein the display speed controlling process includes accelerating and decelerating the display speed of the character information.

22. The authentication information input program product according to claim 21, further comprising the process of selecting character information on the display, wherein the selected character information is sequentially displayed.

23. The authentication information input program product according to claim 22, wherein the authentication information input electronic device includes a plurality of selecting means and a storage section for storing multiple pieces of character information assigned to each selecting means, the multiple pieces of character information assigned to a selected selecting means are read out of the storage section when the selecting means is selected, and the multiple pieces of character information assigned to the selected selecting means is sequentially displayed on the display.

24. The authentication information input program product according to claim 22, wherein the character information is sequentially displayed depending on the number of selected times.

25. The authentication information input program product according to claim 21, further comprising the process of changing a display order to sequentially display the character information in reverse order.

26. The authentication information input program product according to claim 25, wherein the character information is sequentially displayed in reverse order on the display when the display of the character information is halted by deceleration of the display speed in the decelerating process and the display speed of the character information is further decelerated in the decelerating process.

27. The authentication information input program product according to claim 25, wherein the decelerating process accelerates the display speed of the character information when the character information is in reverse order, and the accelerating process decelerates the display speed of the character information when the character information is sequentially displayed in reverse order.

28. The authentication information input program product according to claim 25, further comprising the process of releasing the sequential display of the character information in reverse order.

29. The authentication information input program product according to claim 28, wherein the sequential display of the character information in reverse order is released in the releasing process when the display speed of the character information is decelerated, is halted and is further decelerated in the accelerating process.

30. The authentication information input program product according to claim 21, wherein the determining process includes the processes of:
temporarily determining the character information selected from the character information sequentially displayed on the display; and
duly determining the character information temporarily determined in the temporarily determining process.
